(19) United States
(12) Patent Application Publication
(10) Pub. No.: US 2026/0370689 A1
(43) Pub. Date: Nov. 19, 2026

(54) Cloud-Based Local Data Scanning Management

(71) Applicant: Zscaler, Inc., San Jose, CA (US)

(72) Inventors: Krishnakumar C, Bangalore (IN); Shyam Baitmangalkar, Bangalore (IN); Abhijeet Rawat, Hyderabad (IN); Chandar Dayakar Singh Gadi, Hyderabad (IN); Parag Sharma, Pune (IN); Lokanadha Venkata Rama Chandra Sai Kishore Tummalapalli, Hyderabad (IN); Raghavendra Prasad, Bangalore (IN); Rohit Rawat, Bangalore (IN)

(73) Assignee: Zscaler, Inc., San Jose, CA (US)

(21) Appl. No.: 19/252,294

(22) Filed: Jun. 27, 2025

(30) Foreign Application Priority Data
May 14, 2025 (IN) 202541046339

(51) Int. Cl. H04L 9/40

(52) U.S. Cl. CPC H04L 63/20

(57) ABSTRACT

Systems and methods include establishing an orchestrator instance within a hub account of a customer cloud organization to organize data scanning operations across one or more regions where data of one or more target accounts within the customer cloud organization resides; dynamically launching one or more scanner instances by the orchestrator instance in response to a scan request received from a cloud-based system within the hub account of the customer cloud organization, in the one or more regions where the data scanning operations are performed; and performing, by the one or more scanner instances within the hub account of the customer cloud organization, the data scanning operations on the data of the one or more target accounts in the one or more regions where the data resides.

### FIELD OF THE DISCLOSURE

The present disclosure relates generally to networking and computing. More particularly, the present disclosure relates to cloud-based local data scanning management.

### BACKGROUND OF THE DISCLOSURE

As enterprises increasingly adopt cloud computing models, they structure their data across various platforms within a cloud organization, which can include multiple cloud accounts, each serving distinct functions and business units. These platforms may include Software as a Service (SaaS), Infrastructure as a Service (IaaS), hybrid environments, on-premises deployments, databases, object stores, and other proprietary environments. Given the distributed nature of data across these platforms and accounts, the need for continuous data scanning and monitoring becomes essential to ensure the security, compliance, and privacy of sensitive information within the cloud organization. Traditional scanning solutions, such as those involving third-party vendors, require the data to be transferred out of the cloud organization to a remote cloud or data center for data scanning. Such solutions introduce several challenges, including significant data security and privacy concerns. When sensitive data is moved outside of the cloud organization to an external location, it increases the risk of exposure to third-party vendors and the possibility of data leakage. Even with strict compliance controls in place, many enterprises remain hesitant about such scanning solutions due to concerns regarding data privacy, as the data resides outside their secured cloud infrastructure.

Additionally, there are regulatory compliance issues, particularly surrounding data sovereignty and residency requirements. Transferring data across geographic boundaries can violate local laws and regulations, making it difficult for enterprises to ensure compliance with all relevant frameworks. Furthermore, cost and network latency issues arise when remote scanning is employed. Data transfer costs become particularly burdensome when large volumes of data must be moved outside of the cloud organization, potentially leading to significant overruns. The process of transferring and scanning large datasets remotely also introduces high network latency, causing delays in scanning operations and reducing overall efficiency. These challenges make traditional remote scanning solutions increasingly difficult to implement effectively, creating a need for more efficient, secure, and compliant methods of data scanning within the cloud organization itself. These enterprises require more holistic approaches to security posture management, ensuring that the data remains properly protected, and compliance with regulatory frameworks is consistently maintained. Therefore, there exists a need for improved systems that perform data scanning operations locally within the cloud organization, enhancing enterprises' security posture, ensuring that the data is scanned where it resides without unnecessary movement to external environments, and reducing risks such as unauthorized access, data leaks, and compliance violations.

### BRIEF SUMMARY OF THE DISCLOSURE

In an embodiment, a method, instructions in a non-transitory computer-readable storage medium, and a cloud-based system are presented to perform steps. The steps include establishing, within a hub account of a customer cloud organization, an orchestrator instance to organize data scanning operations across one or more regions where data of one or more target accounts within the customer cloud organization resides; in response to a scan request received from the cloud-based system, dynamically launching one or more scanner instances by the orchestrator instance within the hub account of the customer cloud organization, in the one or more regions where the data scanning operations are performed; and performing, by the one or more scanner instances within the hub account of the customer cloud organization, the data scanning operations on the data of the one or more target accounts in the one or more regions where the data resides.

The establishing can include deploying Data Security Posture Management (DSPM) templates to create Identity and Access Management (IAM) roles and permissions in the customer cloud organization using Cloud Service Provider (CSP) Application Programming Interfaces (APIs). The IAM roles can include an orchestrator instance profile role which is used by the orchestrator instance in the hub account to organize the data scanning operations; a scanner instance profile role which is used by the one or more scanner instances in the hub account to perform the data scanning operations organized by the orchestrator instance; and a target role which is assigned to one or more cloud accounts. The cloud accounts can become the one or more target accounts enabling the one or more scanner instances to access resources within the one or more target accounts to perform the data scanning operations. The deploying can include the IAM roles and permissions created by the DSPM templates that are used by the cloud-based system, the hub account, and the one or more target accounts. The performing can include creating resources within a scanner virtual private cloud (VPC) located within the hub account of the customer cloud organization; and mirroring the data from the one or more target accounts into the resources created within the scanner VPC. The scanner VPC can host the one or more scanner instances in a scanner private subnet. The resources can include a database and a disk. The steps can further include deleting, in response to completion of the data scanning operations, the one or more scanner instances along with the resources created within the scanner VPC for performing the data scanning operations. The performing can further include accessing, by the one or more scanner instances, the data from a cloud storage of the one or more target accounts via a gateway or private endpoint. The steps can further include generating scan results in response to performing the data scanning operations; and sending, by the one or more scanner instances, metadata of the scan results to the cloud-based system. The orchestrator instance can be hosted in an orchestrator private subnet of an orchestrator virtual private cloud (VPC). The orchestrator private subnet can allow the orchestrator instance to send health logs to the cloud-based system. The orchestrator VPC and the scanner VPC can be peered using peering connections, establishing a private communication between the orchestrator instance and the one or more scanner instances.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a network illustrating conventional data scanning;

FIG. 2 is a network diagram of a cloud-based system offering local data scanning as a service;

FIG. 3 is a block diagram of a server that may be used in the cloud-based system of FIG. 1 or the like;

FIG. 4 is a block diagram of a user device that may be used with the cloud-based system of FIG. 1 or the like;

FIG. 5 is a network diagram of a DSPM service implemented via the cloud-based system;

FIG. 6 is a network diagram of IAM roles implemented via the `cloud-based system;

FIG. 7 is a block diagram of an exemplary hub and spoke model implemented via the cloud-based system;

FIG. 8 is a network diagram of a single scanner instance performing data scanning operations within a customer cloud organization;

FIG. 9 is a network diagram of multiple scanner instances performing the data scanning operations within the customer cloud organization; and

FIG. 10 is a flow chart of a process for cloud-based local data scanning management.

### DETAILED DESCRIPTION OF THE DISCLOSURE

Again, the present disclosure relates to cloud-based local data scanning management. Various embodiments focus on performing secure data scanning operations within a customer cloud organization, enabling real-time security, compliance, and privacy monitoring without transferring sensitive data outside of cloud infrastructure. The disclosed system facilitates continuous, efficient, and compliant data scanning within various cloud accounts, regions, and Virtual Private Clouds (VPCs), ensuring that sensitive information remains protected while complying with regulatory requirements.

Also, the present disclosure relates to systems and methods for orchestrating data scans within a cloud-based organization. As described herein, an orchestrator instance is deployed within a designated hub account of a customer cloud organization. An orchestrator can manage and coordinate the launch of scanner instances across various cloud accounts and regions, enabling flexible and scalable data scanning. A customer cloud organization can utilize predefined Data Security Posture Management (DSPM) templates to configure and assign appropriate roles and permissions to the various cloud accounts, ensuring compliance with organizational security and privacy policies.

Moreover, the present disclosure relates to systems and methods for performing localized data scanning within a customer cloud organization. By deploying dedicated scanner instances within private subnets of VPCs, the system can ensure that sensitive data is scanned in a secure and isolated environment. As described herein, the disclosed system can utilize private endpoints, peering, and other secure communication channels to interact with the target resources in the customer cloud organization, ensuring that all scanning operations are conducted in compliance with data sovereignty and security policies.

The present disclosure also relates to techniques for handling scan results, including metadata collection and forwarding. As described herein, the system can generate health logs and scan results, which are then forwarded through secure, encrypted channels for analysis. These logs and results are for tracking the status of scans, detecting anomalies, and providing insights into the overall security posture of the customer cloud organization. The metadata of the scan results can be processed by other components of the system to trigger alerts, initiate corrective actions, and ensure that compliance requirements are continuously met.

The disclosed system provides robust security and compliance capabilities through continuous monitoring, scanning, and reporting. The scanning mechanisms include full and incremental scans, with a focus on efficiency and minimizing system impact. The system can support multiple types of data resources such as databases, cloud storage, and disks, which may reside in various regions or VPCs. By leveraging private endpoints, the system can perform secure, efficient, and scalable data scans across diverse environments, enhancing the customer’s ability to maintain compliance without the need for external scanning services.

### Conventional data scanning

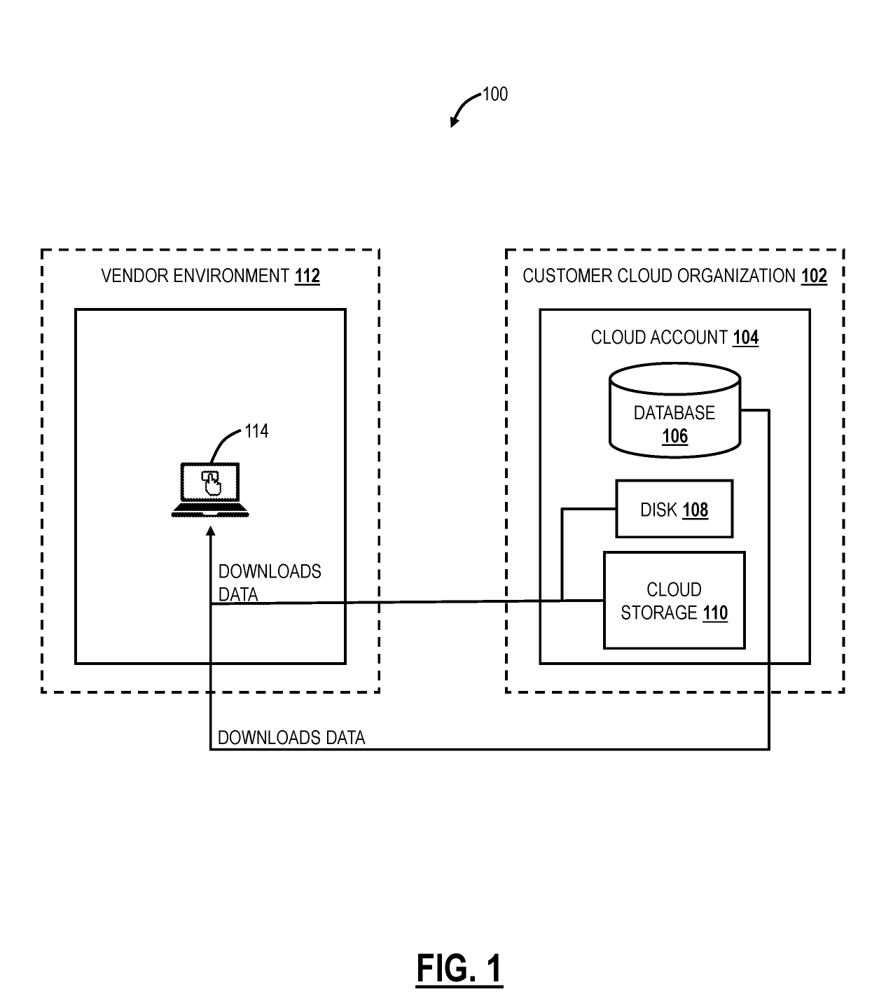

FIG. 1 is a network diagram of a network 100 illustrating conventional data scanning. The network 100 includes a customer cloud organization 102 and a vendor environment 112. The vendor environment 112 includes a remote scanner 114 that downloads data from the customer cloud organization 102 for remote data scanning. The customer cloud organization 102 includes a cloud account 104, which includes multiple resources such as a database 106, disk 108, and cloud storage 110.

In the vendor based data scanning, the data is transferred from the customer cloud organization 102 to the vendor environment 112 for scanning. Once the data is received within the remote scanner 114, a scanning process begins to identify sensitive or misconfigured data. Importantly, this conventional data scanning process involves external scanning services, which typically download the data and perform checks on it outside the customer cloud organization 102.

This conventional data scanning process poses challenges, such as security concerns due to the movement of sensitive data outside of the customer cloud organization 102, compliance issues related to data sovereignty, and inefficiencies caused by transferring large volumes of data. Since the data is transferred from the customer cloud organization 102 to the vendor environment 112, the data is potentially exposed to unauthorized access. Although the vendor discards the data after the remote scanning process, the data resides within the vendor environment 112 during the scan, thereby introducing the risk of data compromise or leakage. This raises concerns over the security and privacy of customer data, as it is moved outside the customer cloud organization 102 and placed into an environment that may not adhere to the same security policies and controls as the customer cloud organization 102.

### Example cloud-based system architecture

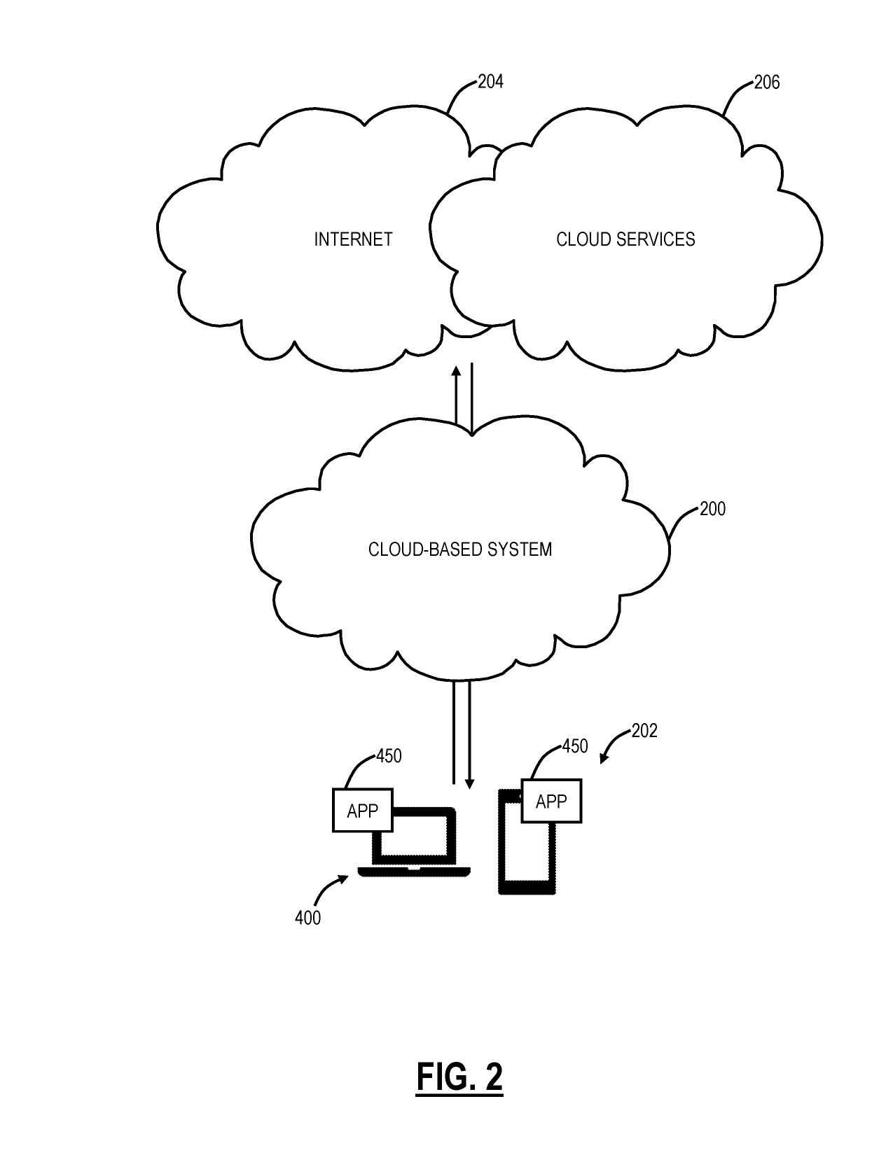

FIG. 2 is a network diagram of a cloud-based system 200 offering local data scanning as a service. Specifically, the cloud-based system 200 can offer a Secure Internet and Web Gateway as a service to users 202, as well as other cloud services. In this manner, the cloud-based system 200 is located between the users 202 and the Internet as well as any cloud services 206 (or applications) accessed by the users 202. As such, the cloud-based system 200 provides inline monitoring inspecting traffic between the users 202, the Internet 204, and the cloud services 206, including SSL/TLS traffic. The cloud-based system 200 can offer local data scanning. The cloud-based system 200 is configured to provide local data scanning services to the users 202 through applications 450 installed on user devices 400. The user devices 400 can include various types of devices, such as personal or enterprise-managed devices, through which the users 202 access cloud services 206 and the Internet 204.

The cloud-based system 200 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client’s web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 200 is illustrated herein as an example embodiment of a cloud-based system, and other implementations are also contemplated.

The application 450 on the user device 400 provides an interface or portal to the local data scanning services provided by the cloud-based system 200. Specifically, the application 450 enables the users 202 to interact with the cloud-based system 200 seamlessly and securely, allowing access to insights and reports generated by local data scans conducted within the customer cloud organization 102. The application 450 can automatically forward user traffic with the cloud-based system 200 as well as ensuring that security and access policies are enforced, regardless of device, location, operating system, or application. The application 450 automatically determines if the users 202 are looking to access the open Internet 204, a SaaS app, or an internal app running in public, private, or the datacenter and routes mobile traffic through the cloud-based system 200. The application 450 can support various cloud services, including Zscaler Internet Access (ZIA), Zscaler Private Access (ZPA), and Zscaler Digital Experience (ZDX), all from Zscaler, Inc. (the assignee and applicant of the present application), allowing the best in class security with zero trust access to internal apps. As described herein, the application 450 can also be referred to as a connector application.

Further, the application 450 can detect trusted networks, allowed applications, etc. and support secure network access. The application 450 can also support the enrollment of the user device 400 prior to accessing applications. The application 450 can uniquely detect the users 202 based on fingerprinting the user device 400, using criteria like device model, platform, operating system, etc. The application 450 can support Mobile Device Management (MDM) functions, allowing IT personnel to deploy and manage the user devices 400 seamlessly. This can also include the automatic installation of client and SSL certificates during enrollment. Finally, the application 450 provides visibility into device and app usage of the users 202 of the user device 400.

The application 450 supports a secure, lightweight tunnel between the user device 400 and the cloud-based system 200. For example, the lightweight tunnel can be HTTP-based. With the application 450, there is no requirement for PAC files, an IPSec VPN, authentication cookies, or user setup. The cloud-based system 200 communicates securely with the application 450 installed on the user devices 400. Communication between the application 450 and the cloud-based system 200 may be encrypted and protected against unauthorized access. This ensures that sensitive information and scanning insights remain confidential and secure, aligning with organizational security and privacy policies.

### Example server architecture

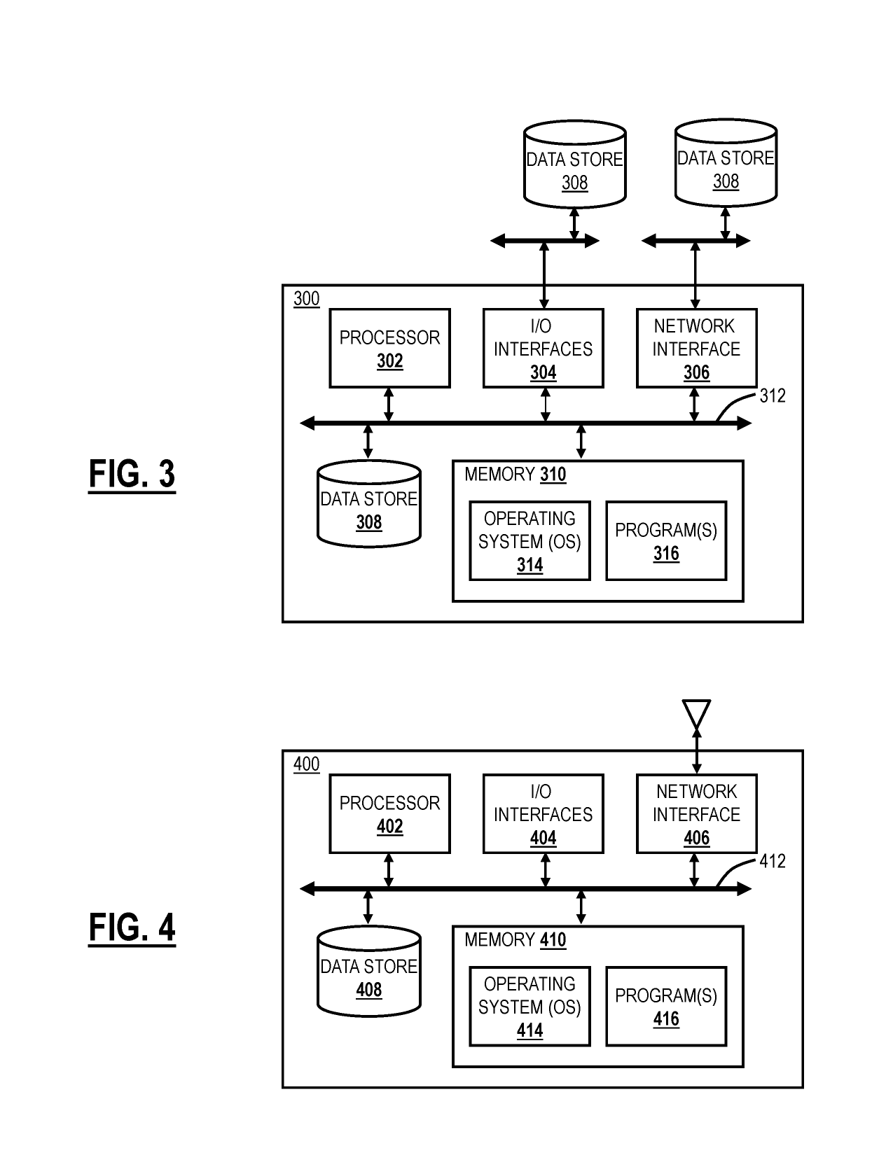

FIG. 3 is a block diagram of a server 300, which may be used in the cloud-based system 200, in other systems, or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 3 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example, but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a Central Processing Unit (CPU), an auxiliary processor among several processors associated with the server 300, a semiconductor-based microprocessor (in the form of a microchip or chipset), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components.

The network interface 306 may be used to enable the server 300 to communicate on a network, such as the Internet 204. The network interface 306 may include, for example, an Ethernet card or adapter or a Wireless Local Area Network (WLAN) card or adapter. The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300, such as, for example, an internal hard drive connected to the local interface 312 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network-attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 may include one or more software programs, each of which includes an ordered listing of executable instructions for implementing logical functions. The software in the memory 310 includes a suitable Operating System (O/S) 314 and one or more programs 316. The operating system 314 essentially controls the execution of other computer programs, such as the programs 316, and provides scheduling, input-output control, file and data management, memory management, and communication control and related services. The one or more programs 316 may be configured to implement the various processes, algorithms, methods, techniques, etc. described herein.

### Example user device architecture

FIG. 4 is a block diagram of the user device 400, which may be used with the cloud-based system 200 or the like. Specifically, the user device 400 can form a device used by one of the users 202, and this may include common devices such as laptops, smartphones, tablets, netbooks, personal digital assistants, MP3 players, cell phones, e-book readers, IoT devices, servers, desktops, printers, televisions, streaming media devices, and the like. The user device 400 can be a digital device that, in terms of hardware architecture, generally includes a processor 402, I/O interfaces 404, a network interface 406, a data store 408, and memory 410. It should be appreciated by those of ordinary skill in the art that FIG. 4 depicts the user device 400 in an oversimplified manner, and a practical embodiment may include additional components and suitably configured processing logic to support known or conventional operating features that are not described in detail herein. The components (402, 404, 406, 408, and 410) are communicatively coupled via a local interface 412. The local interface 412 can be, for example, but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a CPU, an auxiliary processor among several processors associated with the user device 400, a semiconductor-based microprocessor (in the form of a microchip or chipset), or generally any device for executing software instructions. When the user device 400 is in operation, the processor 402 is configured to execute software stored within the memory 410, to communicate data to and from the memory 410, and to generally control operations of the user device 400 pursuant to the software instructions. In an embodiment, the processor 402 may include a mobile-optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 406 enables wireless communication to an external access device or network. Any number of suitable wireless data communication protocols, techniques, or methodologies can be supported by the network interface 406, including any protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 4, the software in the memory 410 includes a suitable operating system 414 and programs 416. The operating system 414 essentially controls the execution of other computer programs and provides scheduling, input-output control, file and data management, memory management, and communication control and related services. The programs 416 may include various applications, add-ons, etc. configured to provide end-user functionality with the user device 400. For example, example programs 416 may include, but not limited to, a web browser, social networking applications, streaming media applications, games, mapping and location applications, electronic mail applications, financial applications, and the like. In a typical example, the end-user typically uses one or more of the programs 416 along with a network such as the cloud-based system 200.

### Data Security Posture Management

Data Security Posture Management (DSPM) helps protect an organization’s data stored in cloud resources against theft, misuse, or loss by continuously scanning data and identifying numerous potential misconfigurations, vulnerabilities, and permissions issues that might create security risks. DSPM provides detailed insights into the locations of sensitive data within cloud environments, identifies sensitive data types, and detects misconfigurations in data stores containing sensitive data. Enriched and interactive dashboards, graphs, and reports provided by DSPM enable security teams to quickly evaluate the severity of identified risks, remediate issues, and proactively prevent data breaches.

Key features and benefits of DSPM include continuous data monitoring for vulnerabilities, securing sensitive data by discovery, classification, and managing exposure levels, and implementing robust security policies and controls. DSPM also expedites incident response, enabling swift identification, investigation, containment, and recovery in security incidents. Additionally, DSPM leverages agentless deep scanning techniques to continuously scan cloud storage, databases, and virtual machines, efficiently detecting data misconfigurations such as exposed sensitive data or improper access controls. This proactive monitoring capability, combined with actionable insights and remediation guidance, strengthens an organization’s overall cloud data security posture.

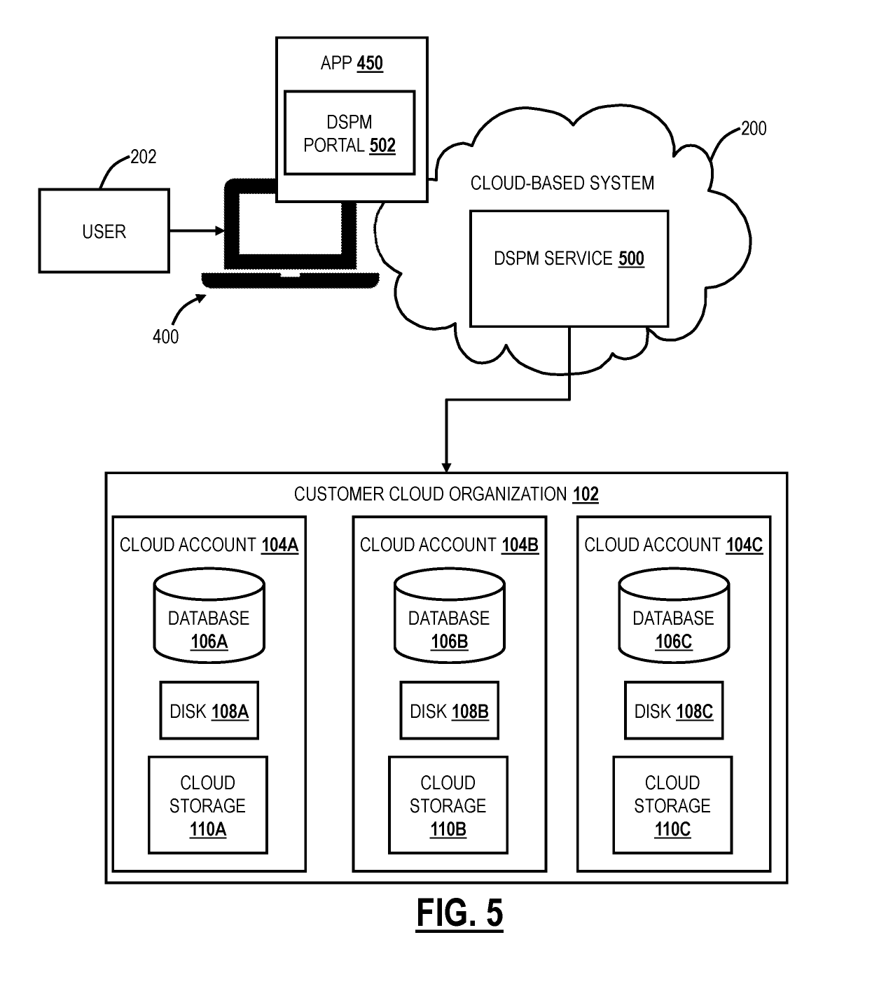

FIG. 5 is a network diagram illustrating the onboarding aspect of a DSPM service 500 implemented via the cloud-based system 200. Specifically, the onboarding of a customer cloud organization 102 with the DSPM service 500 is performed through a DSPM portal 502 accessible via the application 450 on a user device 400. During onboarding, the user 202 inputs specific details required to manage and secure the customer cloud organization 102.

The onboarding process includes collecting several details related to the customer cloud organization 102 by the user 202. These details include a Data Security Posture Management (DSPM) Alias (optional) to uniquely identify the customer cloud organization 102 within the DSPM service 500, a Management Account Name representing the primary management account within the customer cloud organization 102, a Role Name associated with identity and access management (IAM) configurations used for scanning purposes, and a Management Account ID uniquely identifying the management account within the customer cloud organization 102.

Moreover, to effectively track and monitor infrastructure changes across the customer cloud organization 102, the DSPM service 500 utilizes activity logs provided by cloud service providers (CSPs) associated with the customer cloud organization 102. The onboarding process involves integrating the DSPM service 500 with various CSPs, including but not limited to Amazon Web Services (AWS), Microsoft Azure, and Google Cloud Platform (GCP), leveraging Application Programming Interfaces (APIs) and native connectors to facilitate seamless data discovery and continuous monitoring. As part of onboarding, the user 202 configures a logging service by inputting specific parameters, including a Log Bucket Name for securely storing activity logs, an optional Log Prefix for categorizing or segmenting logs, and a Log Bucket Account ID uniquely identifying the specific account within the customer cloud organization 102 hosting the logging bucket.

Prerequisites for onboarding typically include ensuring appropriate permissions and roles are assigned within the customer cloud organization 102, such as permissions to access log data, read resource configurations, and scan data repositories. The DSPM service 500 guides the user 202 through these prerequisites via intuitive instructions within the DSPM portal 502, simplifying the configuration process and ensuring seamless integration.

The DSPM portal 502 facilitates secure communication and transmission of onboarding data between user devices 400 and the cloud-based system 200. All onboarding data provided by the user 202 is securely transmitted and stored with encryption mechanisms, ensuring confidentiality and integrity. Once onboarding is complete, the DSPM service 500 initiates a baseline assessment to establish an initial data security posture for customer cloud accounts 104A, 104B, 104C, which can include diverse resources such as databases 106A, 106B, 106C, disks 108A, 108B, 108C, and cloud storages 110A, 110B, 110C. While FIG. 5 depicts an illustrative example with three customer cloud accounts and associated resources, it should be understood by those skilled in the art that the customer cloud organization 102 may include any suitable number of cloud accounts and resources. Thus, the number and type of resources illustrated are exemplary only and may vary in practical implementations, being greater or fewer depending upon specific customer requirements and configurations within the customer cloud organization 102.

### Identity and Access Management (IAM) roles

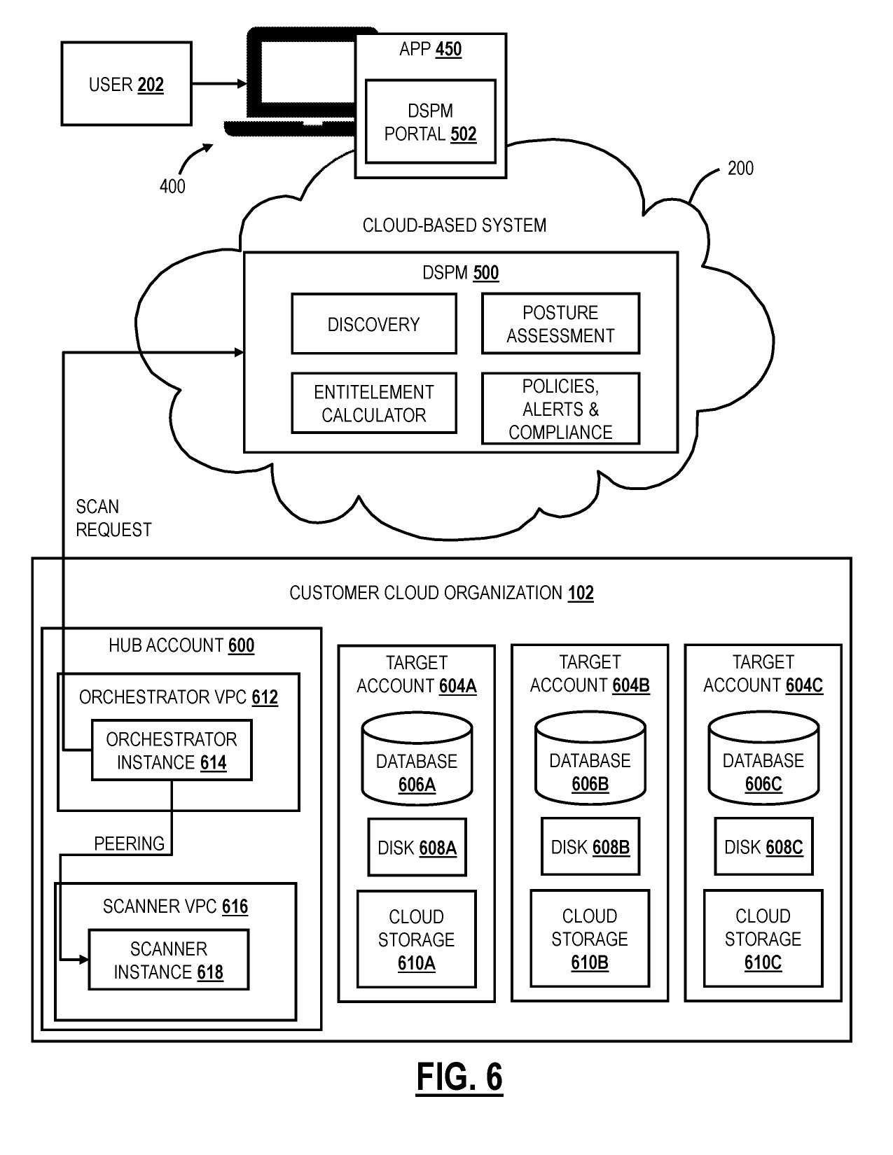

FIG. 6 is a network diagram illustrating Identity and Access Management (IAM) roles implemented via the cloud-based system 200 within the customer cloud organization 102. Specifically, the DSPM service 500, operating within the cloud-based system 200, comprises multiple functional components, including Discovery, Posture Assessment, Entitlement Calculator, and Policies, Alerts & Compliance modules. Each of these components facilitates various aspects of the comprehensive data security posture management provided by the DSPM service 500 to the customer cloud organization 102.

In particular, FIG. 6 illustrates the establishment and utilization of IAM roles and permissions to facilitate secure and organized data scanning operations. As illustrated, the cloud-based system 200 includes the DSPM service 500 that interacts with the customer cloud organization 102, which now includes a hub account 600 and one or more target accounts 604A, 604B, and 604C. These target accounts 604A-604C correspond to and are derived from the cloud accounts 104A-104C described previously with reference to FIG. 5. Each target account (604A, 604B, and 604C) hosts various resources such as databases 606A, 606B, 606C; disks 608A, 608B, 608C; and cloud storages 610A, 610B, and 610C.

The DSPM service 500 initiates a scan request in response to configured scan triggers or policies. The orchestrator instance 614, deployed within an orchestrator Virtual Private Cloud (VPC) 612 of a designated hub account 600 in the customer cloud organization 102, retrieves the scan request from the DSPM service 500 and organizes the corresponding data scanning operations. The orchestrator instance 614 is configured to organize and manage data scanning operations across one or more regions associated with the one or more target accounts within the customer cloud organization 102. Additionally, the hub account 600 includes a scanner VPC 616 that hosts one or more scanner instances 618. These scanner instances 618 are dynamically provisioned and specifically configured to execute the data scanning operations as organized by the orchestrator instance 614. The orchestrator VPC 612 and the scanner VPC 616 are operatively coupled through secure network peering, allowing efficient and secure communication between the orchestrator instance 614 and the scanner instances 618.

The DSPM service 500 of the cloud-based system 200 is configured to deploy Data Security Posture Management (DSPM) templates into the customer cloud organization 102. These DSPM templates establish and configure the IAM roles and associated permissions via Application Programming Interfaces (APIs) provided by the CSPs. In this implementation, three distinct IAM roles are configured within the customer cloud organization 102. Firstly, the IAM roles include an orchestrator instance profile role, which is used explicitly by the orchestrator instance 614 within the orchestrator VPC 612 of the hub account 600. The orchestrator instance profile role enables the orchestrator instance 614 to effectively organize and control the execution of the data scanning operations across the customer cloud organization 102. The IAM roles further include a scanner instance profile role, which is used explicitly to the scanner instances 618 within the scanner VPC 616 of the hub account 600. The scanner instance profile role enables scanner instances 618 to securely perform the data scanning operations as directed by the orchestrator instance 614, allowing access to the resources hosted within the one or more target accounts 604A, 604B, and 604C. The IAM roles further include a target role assigned explicitly to each customer cloud account 104A, 104B, and 104C within the customer cloud organization 102, thereby designating the customer cloud accounts 104A, 104B, and 104C as the target accounts 604A, 604B, and 604C, respectively. The target role provides defined and controlled permissions for scanner instances 618, enabling them to access and interact securely with resources such as databases 606A-606C, disks 608A-608C, and cloud storages 610A-610C residing within these target accounts 604A-604C. This role facilitates necessary operations such as resource discovery, data extraction, snapshot creation, and other data scanning activities within each target account 604A-604C.

Deployment of these DSPM templates inherently establishes a trust relationship among the cloud-based system 200, the hub account 600, and the respective target accounts 604A-604C within the customer cloud organization 102. This trust relationship is explicitly based on the IAM roles and permissions configured by the DSPM templates, ensuring that all interactions and operations across these accounts are governed by precise security controls, and adhering strictly to defined security and privacy policies.

While FIG. 6 depicts an illustrative example comprising a single orchestrator instance 614, a single scanner instance 618, and three target accounts 604A-604C, those skilled in the art will appreciate that in practical implementations, the customer cloud organization 102 can include multiple orchestrator instances, multiple scanner instances, and any suitable number of target accounts, along with varying resource types and configurations depending on specific organizational security requirements and operational complexities.

### Hub and Spoke Model

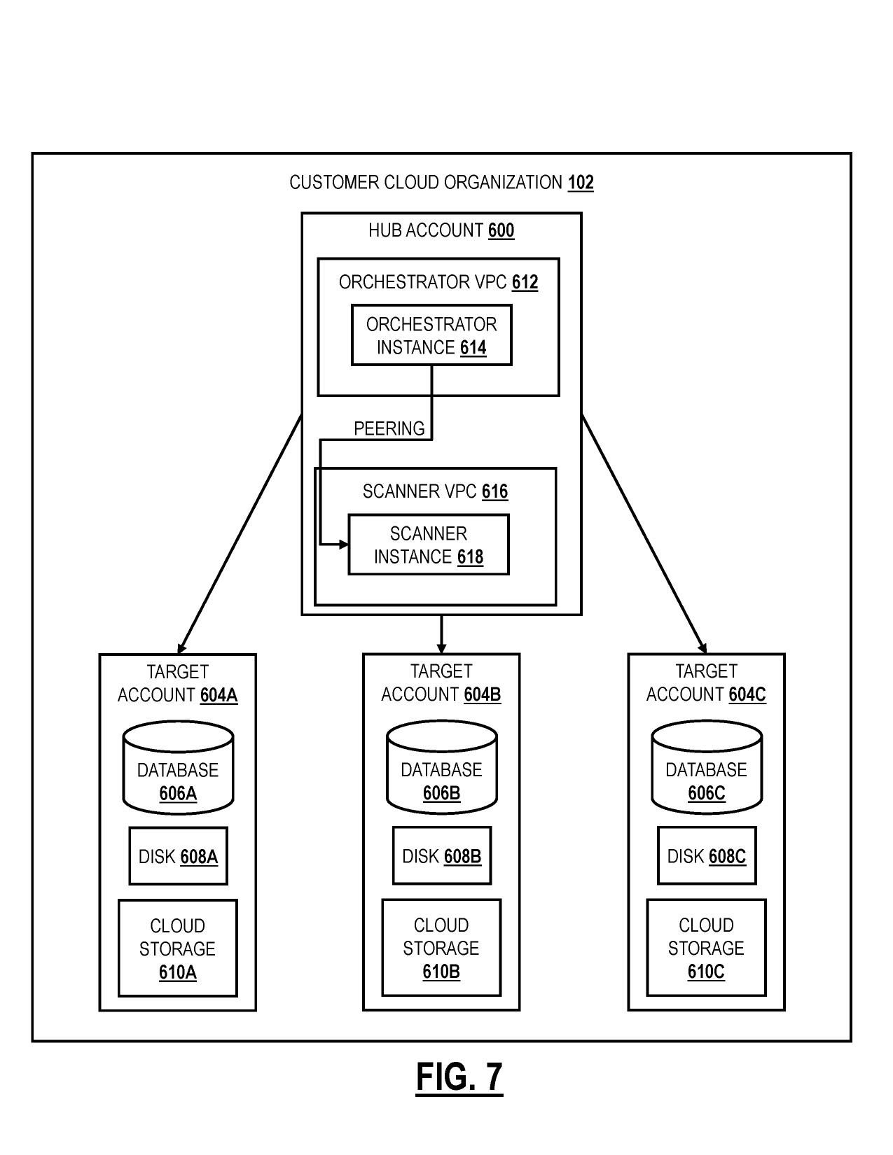

FIG. 7 is a block diagram illustrating an exemplary hub and spoke model implemented via the cloud-based system 200 within the customer cloud organization 102. Specifically, FIG. 7 elaborates upon the architectural deployment of the DSPM scanning solution, leveraging a structured hub and spoke model. In this configuration, the hub account 600 acts as the central administrative and operational entity within the customer cloud organization 102, consolidating management, control, and operational execution of scanning functions into a singular, centralized environment.

Within the hub account 600, the orchestrator instance 614 is established inside the orchestrator VPC 612. The orchestrator instance 614 organizes and oversees the execution of scanning activities across multiple target accounts 604A, 604B, and 604C, collectively forming the spokes of the model. Additionally, a dedicated scanner VPC 616 is provisioned within the hub account 600, securely connected to the orchestrator VPC 612 via VPC peering connections, facilitating secure and isolated communication between the orchestrator instance 614 and the scanner instance 618. The scanner instance 618, residing within the scanner VPC 616, executes the data scanning operations directed by the orchestrator instance 614.

Importantly, the scanner instances 618 are intentionally deployed within the centralized hub account 600 rather than in each individual target account 604A, 604B, and 604C, aligning with security and operational best practices. This centralized deployment model addresses specific customer requirements and security considerations, as customers typically prefer not to have external scanning components directly installed within every cloud account. Such dispersed installation across multiple accounts could increase security risks. If a scanner instance were compromised within an individual target account, it could pose significant risks to data security across the customer cloud organization 102. Consequently, centralizing scanner instances within the hub account 600 significantly reduces these potential security vulnerabilities.

Furthermore, the data scanning operations conducted by the scanner instance 618 do not directly interact with active or primary resources of the target accounts 604A, 604B, and 604C. Instead, the data scanning operations are performed on copies or snapshots of the resources, such as copies of the databases 606A, 606B, and 606C; the disks 608A, 608B, and 608C; and the cloud storages 610A, 610B, and 610C. By scanning replicated data resources rather than actual production data resources within the target accounts 604A, 604B, and 604C, the DSPM service 500 further mitigates operational risks, preventing unintended disruptions or performance degradation of customer operations and ensuring data integrity and confidentiality are preserved throughout the scanning processes.

Thus, the hub and spoke model illustrated in FIG. 7 provides an efficient, secure, and customer-oriented solution for data security posture management. Centralizing orchestration and scanning operations within the hub account 600 while using securely managed replicas of target data resources ensures comprehensive scanning coverage and robust security, maintaining compliance with organizational and regulatory requirements and enhancing the overall security posture of the customer cloud organization 102.

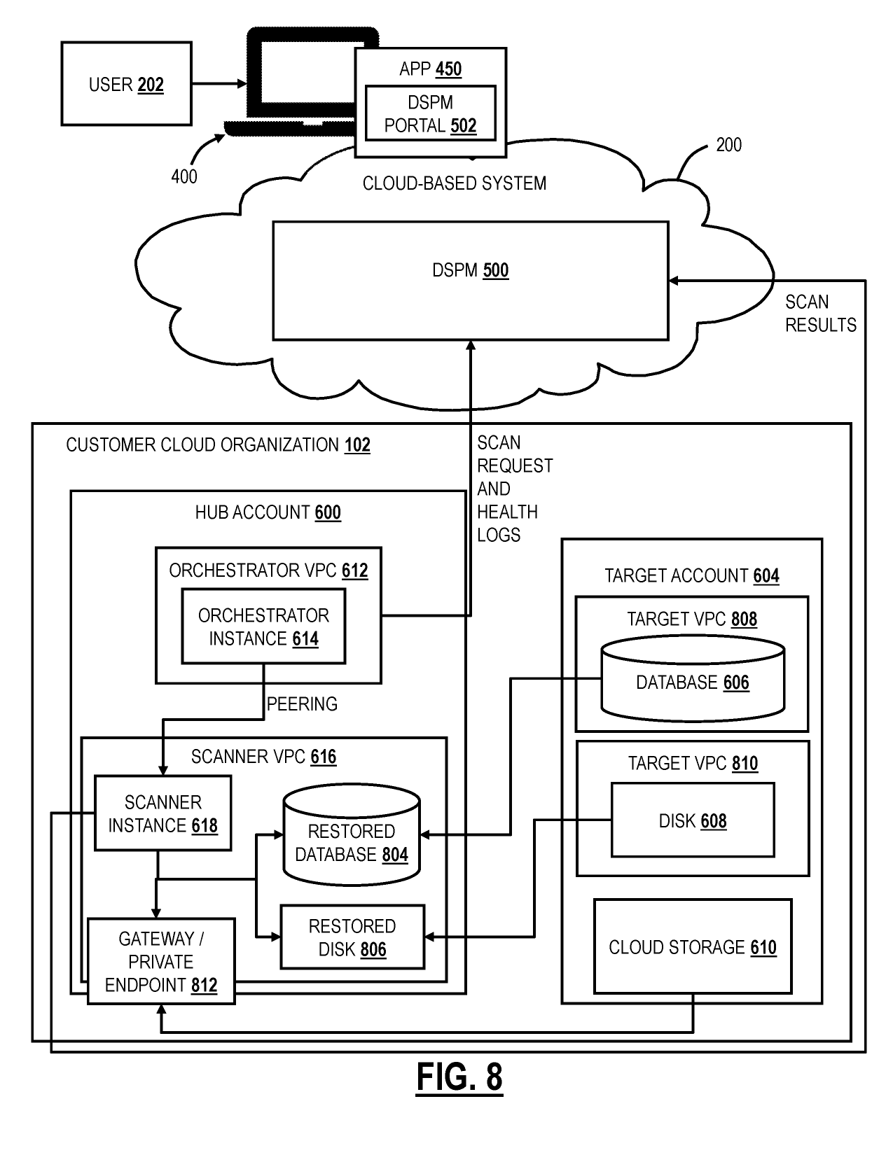

FIG. 8 is a network diagram of a single scanner instance 618 performing the data scanning operations within the customer cloud organization 102 using the cloud-based system 200. In particular, the DSPM service 500, implemented within the cloud-based system 200, manages scanning tasks, data transfers, health logs, and scan results. Specifically, as illustrated in FIG. 8, the data scanning operations begin when the orchestrator instance 614, deployed within the orchestrator VPC 612 of the hub account 600, actively pulls a scan request made available by the DSPM service 500. This pull-based interaction ensures that scan orchestration remains secure, controlled, and decoupled from any particular cloud provider implementation.

Within the hub account 600, the orchestrator instance 614 is deployed within an orchestrator Virtual Private Cloud (VPC) 612. The orchestrator instance 614 pulls scan requests from the DSPM 500 and manages the data scanning operations. Importantly, the orchestrator instance 614 is located within an orchestrator private subnet, which inherently restricts inbound communication from public networks. The orchestrator private subnet facilitates secure outbound communication, allowing the orchestrator instance 614 to transmit health logs to the DSPM service 500 over encrypted Transport Layer Security (TLS) channels. The orchestrator private subnet also ensures that the orchestrator instance 614 is not directly accessible from the public internet, enhancing security and isolation.

Upon processing the scan request, the orchestrator instance 614 dynamically launches one scanner instance 618 within a scanner VPC 616 of the hub account 600. The scanner instance 618 is specifically deployed in a private subnet within the scanner VPC 616. Specifically, the orchestrator instance 614 selects the region for deploying the scanner instance 618 based explicitly on the geographic region of the data resources within the target account 604. Because all resources, including the database 606 within the target VPC 808, the disk 608 within the target VPC 810, and the cloud storage 610 of the target account 604, are located in the same geographic region, the orchestrator instance 614 launches only a single scanner instance 618 in that specific region. Consequently, this region-specific deployment enhances operational efficiency, reduces latency, and ensures compliance with data residency requirements within the customer cloud organization 102.

The scanner instance 618 operates securely within the scanner VPC 616, and the scanner VPC 616 includes dedicated resources such as a database 804 and a disk 806. These resources are dynamically provisioned within scanner VPC 616 to facilitate the data scanning operations. Notably, to maintain the integrity and performance of the production resources of the target account 604, the scanner instance 618 does not directly operate on active data. Instead, the scanner instance 618 mirrors or creates snapshots of data resources from the target account 604, including database 606 hosted in a target VPC 808 and disk 608 hosted in a target VPC 810. These mirrored copies or snapshots are stored securely within database 804 and disk 806 resources in the scanner VPC 616.

The scanner instance 618 accesses cloud storage 610 of the target account 604 using a securely configured gateway or private endpoint 812. The private endpoint 812 ensures private and direct connectivity between scanner VPC 616 and cloud storage 610 within target account 604, avoiding exposure of data over public networks. This private endpoint facilitates secure and efficient transfer of data needed for the data scanning operations. The scanner instance 618 performs comprehensive data scanning operations on the data mirrored with the database 804 and the disk 806, and received from the cloud storage 610 via the private endpoint 812. Upon completion of the data scanning operations, the scanner instance 618 generates scan results, including metadata related to identified data security risks, misconfigurations, vulnerabilities, and sensitive data exposure. The scanner instance 618 subsequently transmits the metadata of the scan results securely back to the DSPM service 500. The scanner instance 618 communicates securely with the DSPM service 500, ensuring scan result transmissions occur over secure, encrypted channels (TLS), and simultaneously preventing unauthorized inbound communications.

The orchestrator VPC 612 and the scanner VPC 616 within the hub account 600 are connected via secure network peering connections. This VPC peering ensures fully isolated and private communication pathways between the orchestrator instance 614 and the scanner instance 618, thus maintaining security, privacy, and integrity throughout the data scanning operations. Following the secure transmission of the metadata of the scan results, the orchestrator instance 614 automatically deletes the scanner instance 618, along with associated resources such as the database 804, the disk 806, and snapshots or mirrored data created specifically for the data scanning operations. This ephemeral, dynamic provisioning and deletion of scanner resources ensures minimal operational footprint and optimized resource utilization within the customer cloud organization 102.

Security measures integral to the scanning process include the use of securely stored API keys managed within a secrets manager (not explicitly shown) that are utilized exclusively by the orchestrator instance 614 and the scanner instance 618 for secure communication with the DSPM service 500. Public access to this secrets manager is disabled, permitting access only from authorized orchestrator and scanner instance identities. All the data scanning operations performed by the scanner instance 618 and the orchestrator instance 614 rely solely on private IP addresses, avoiding exposure to public internet-based threats. The orchestrator instance 614 and the scanner instance 618 are deployed within respective private subnets of the orchestrator VPC 612 and the scanner VPC 616, respectively, configured to allow secure, outbound-only communication to the DSPM service 500 while preventing any inbound connectivity from public networks, thereby significantly enhancing isolation and protection against unauthorized access.

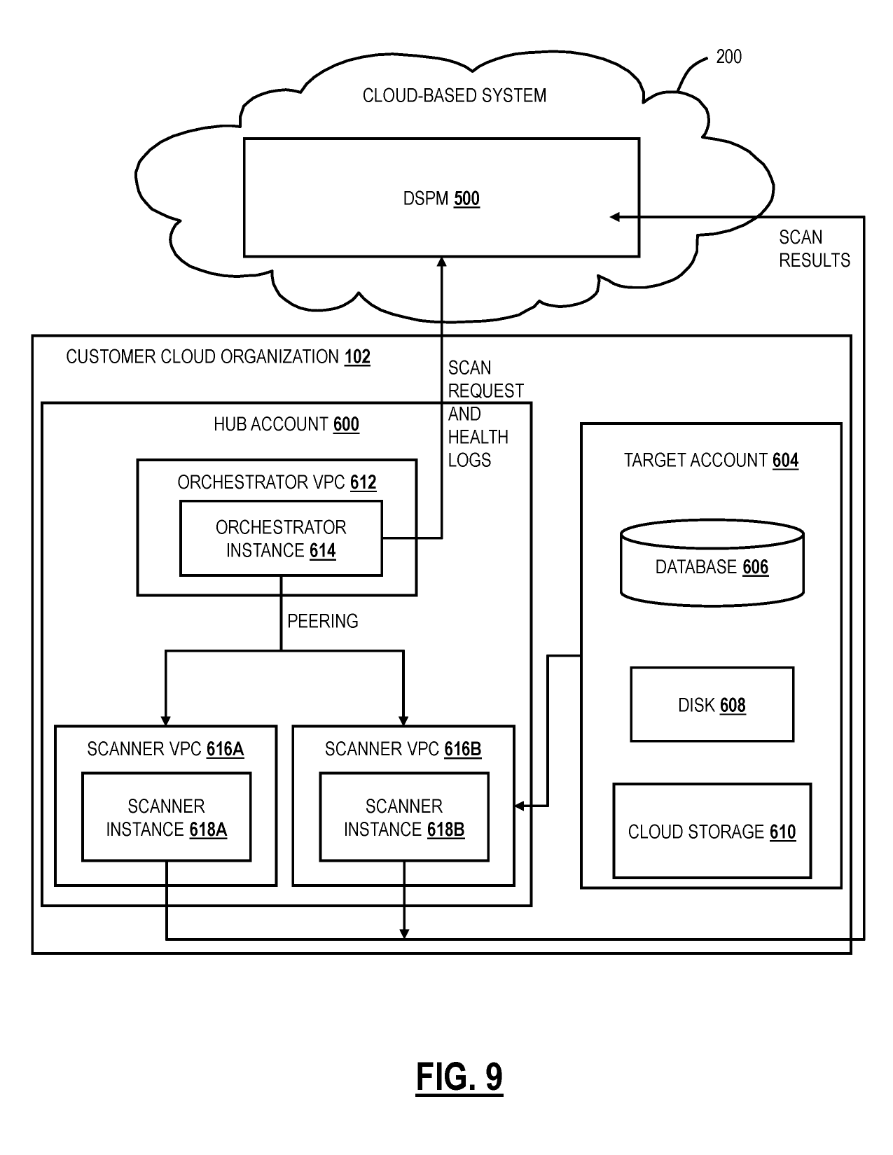

FIG. 9 is a network diagram of multiple scanner instances 618A, 618B performing the data scanning operations within the customer cloud organization 102 using the cloud-based system 200. FIG. 9 illustrates an embodiment where multiple scanner instances are required to concurrently perform the data scanning operations across various resources of the target account 604. This scenario may arise when the resources to be scanned are distributed across multiple regions. The deployment continues to leverage the hub and spoke model architecture, wherein the orchestrator and scanner instances are confined within the hub account 600 of the customer cloud organization 102.

As in prior embodiments, the DSPM service 500, implemented within the cloud-based system 200, makes a scan request available to be retrieved by the orchestrator instance 614. The orchestrator instance 614, which is deployed within the orchestrator VPC 612 of the hub account 600 in the customer cloud organization 102, actively pulls the scan request from the DSPM service 500. In this manner, the scan request is transmitted to the orchestrator instance 614 only upon being consumed by the orchestrator instance 614, allowing the orchestration of data scanning operations to proceed in a secure and controlled manner, independent of the underlying cloud service provider.

Within the hub account 600, the orchestrator instance 614 is deployed inside an orchestrator Virtual Private Cloud (VPC) 612. The orchestrator instance 614 retrieves scan requests from the DSPM service 500 and organizes the execution of the corresponding data scanning operations. The orchestrator instance 614 resides in an orchestrator private subnet, which provides inherent protection from unsolicited inbound communication. The orchestrator private subnet allows the orchestrator instance 614 to send outbound communications securely to the DSPM service 500, such as health logs, over Transport Layer Security (TLS) channels. The orchestrator private subnet further ensures that no inbound communication from the public Internet is permitted, enhancing the isolation and security of the orchestrator instance 614.

In the embodiment shown in FIG. 9, the orchestrator instance 614, deployed within the orchestrator Virtual Private Cloud (VPC) 612 of the hub account 600 in the customer cloud organization 102, dynamically provisions two scanner instances 618A and 618B. These scanner instances are launched within corresponding scanner Virtual Private Clouds 616A and 616B, respectively, each provisioned within the hub account 600. The deployment of multiple scanner VPCs and corresponding scanner instances in this embodiment results from the fact that the data resources to be scanned within the target account 604 are geographically distributed across two distinct regions. Specifically, the database 606, the disk 608, and the cloud storage 610 within the target account 604 are replicated or mirrored across two different geographical regions within the customer cloud organization 102, each requiring a region-local scanner instance to perform localized data scanning operations efficiently.

As such, the orchestrator instance 614 selects and launches the scanner instance 618A in a first region by creating the scanner VPC 616A, and the scanner instance 618B in a second region by creating the scanner VPC 616B. This region-specific provisioning ensures that data scanning operations are performed in proximity to the respective data resources of the target account 604, thereby minimizing latency, improving data transfer efficiency, and ensuring compliance with regional data residency requirements. Each scanner VPC 616A and 616B is connected to the orchestrator VPC 612 via dedicated VPC peering connections, facilitating secure, private, and encrypted communication between the orchestrator instance 614 and both scanner instances 618A and 618B, regardless of the region in which they operate.

The scanner instance 618A deployed within the scanner VPC 616A, and the scanner instance 618B deployed within the scanner VPC 616B, perform the data scanning operations on the mirrored data that is locally stored within their respective scanner VPCs. The mirrored data originates from corresponding region-specific resources of the target account 604 within the customer cloud organization 102, such as the database 606, the disk 608, and the cloud storage 610, which reside across two distinct geographical regions. Accordingly, each scanner instance 618A, 618B is responsible for scanning the subset of data mirrored from the region in which it operates. During the data scanning operations, each scanner instance identifies sensitive data patterns, detects misconfigurations, and analyzes potential policy violations. The results of these operations are compiled in the form of metadata. The metadata is then securely transmitted from the scanner instances 618A and 618B to the DSPM service 500 through outbound-only communication channels established from their respective private subnets. The metadata of the scan results may subsequently be accessed by the users 202 through the DSPM portal 502 or utilized to initiate automated remediation workflows defined within the DSPM service 500.

While FIG. 9 illustrates a specific embodiment involving two scanner instances 618A and 618B, those skilled in the art will recognize that the number of scanner instances may vary depending on the number of geographic regions in which the data and associated resources of one or more target accounts 604 are located within the customer cloud organization 102.

### Cloud-based local data scanning management process

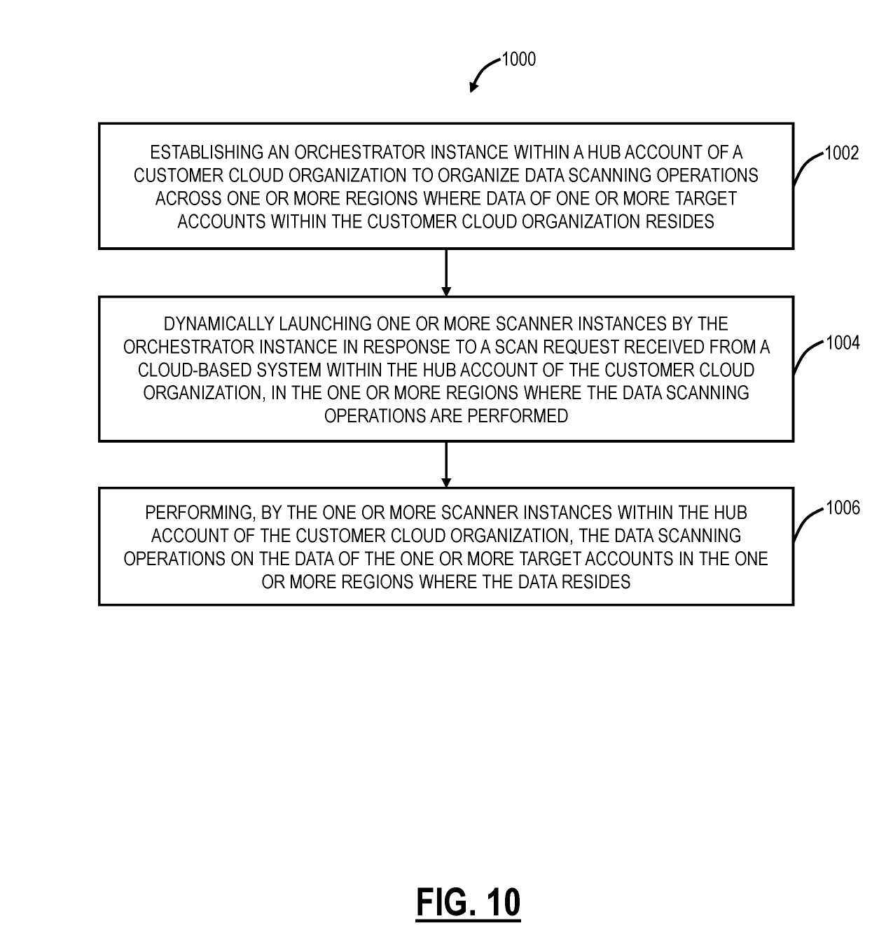

FIG. 10 is a flow chart of a process for cloud-based local data scanning management. In various embodiments, the process 1000 can be contemplated as a method having steps, a processing device configured to implement the steps, a cloud-based system configured to implement the steps, and as a non-transitory computer-readable medium storing instructions for programming one or more processors to execute the steps. The process 1000 includes establishing an orchestrator instance within a hub account of a customer cloud organization to organize data scanning operations across one or more regions where data of one or more target accounts within the customer cloud organization resides (step 1002); dynamically launching one or more scanner instances by the orchestrator instance in response to a scan request received from a cloud-based system within the hub account of the customer cloud organization, in the one or more regions where the data scanning operations are performed (step 1004); and performing, by the one or more scanner instances within the hub account of the customer cloud organization, the data scanning operations on the data of the one or more target accounts in the one or more regions where the data resides (step 1006).

The establishing can include deploying Data Security Posture Management (DSPM) templates to create Identity and Access Management (IAM) roles and permissions in the customer cloud organization using Cloud Service Provider (CSP) Application Programming Interfaces (APIs). The IAM roles can include an orchestrator instance profile role which is used by the orchestrator instance in the hub account to organize the data scanning operations; a scanner instance profile role which is used by the one or more scanner instances in the hub account to perform the data scanning operations organized by the orchestrator instance; and a target role which is assigned to one or more cloud accounts. The cloud accounts can become the one or more target accounts enabling the one or more scanner instances to access resources within the one or more target accounts to perform the data scanning operations. The deploying can include the IAM roles and permissions created by the DSPM templates that are used by the cloud-based system, the hub account, and the one or more target accounts. The performing can include creating resources within a scanner virtual private cloud (VPC) located within the hub account of the customer cloud organization; and mirroring the data from the one or more target accounts into the resources created within the scanner VPC. The scanner VPC can host the one or more scanner instances in a scanner private subnet. The resources can include a database and a disk. The process 1000 can further include deleting, in response to completion of the data scanning operations, the one or more scanner instances along with the resources created within the scanner VPC for performing the data scanning operations. The performing can further include accessing, by the one or more scanner instances, the data from a cloud storage of the one or more target accounts via a gateway or private endpoint. The process 1000 can further include generating scan results in response to performing the data scanning operations; and sending, by the one or more scanner instances, metadata of the scan results to the cloud-based system. The orchestrator instance can be hosted in an orchestrator private subnet of an orchestrator virtual private cloud (VPC). The orchestrator private subnet can allow the orchestrator instance to send health logs to the cloud-based system. The orchestrator VPC and the scanner VPC can be peered using peering connections, establishing a private communication between the orchestrator instance and the one or more scanner instances.

### Conclusion

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, processor, circuit, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method implemented by a cloud-based system, the method comprising steps of:
establishing, within a hub account of a customer cloud organization, an orchestrator instance to organize data scanning operations across one or more regions where data of one or more target accounts within the customer cloud organization resides;
in response to a scan request received from the cloud-based system, dynamically launching one or more scanner instances by the orchestrator instance within the hub account of the customer cloud organization, in the one or more regions where the data scanning operations are performed; and
performing, by the one or more scanner instances within the hub account of the customer cloud organization, the data scanning operations on the data of the one or more target accounts in the one or more regions where the data resides.

2. The method of claim 1, wherein the establishing includes deploying Data Security Posture Management (DSPM) templates to create Identity and Access Management (IAM) roles and permissions in the customer cloud organization using Cloud Service Provider (CSP) Application Programming Interfaces (APIs).

3. The method of claim 2, wherein the IAM roles include:
an orchestrator instance profile role which is used by the orchestrator instance in the hub account to organize the data scanning operations;
a scanner instance profile role which is used by the one or more scanner instances in the hub account to perform the data scanning operations organized by the orchestrator instance; and
a target role which is assigned to one or more cloud accounts, wherein the cloud accounts become the one or more target accounts, enabling the one or more scanner instances to access resources within the one or more target accounts to perform the data scanning operations.

4. The method of claim 2, wherein the deploying includes the IAM roles and permissions created by the DSPM templates that are used by the cloud-based system, the hub account, and the one or more target accounts.

5. The method of claim 1, wherein the performing includes:
creating resources within a scanner virtual private cloud (VPC) located within the hub account of the customer cloud organization, wherein the scanner VPC hosts the one or more scanner instances in a scanner private subnet, wherein the resources include a database and a disk; and
mirroring the data from the one or more target accounts into the resources created within the scanner VPC.

6. The method of claim 5, wherein the steps further include deleting, in response to completion of the data scanning operations, the one or more scanner instances along with the resources created within the scanner VPC for performing the data scanning operations.

7. The method of claim 1, wherein the performing further includes accessing, by the one or more scanner instances, the data from a cloud storage of the one or more target accounts via a gateway or private endpoint.

8. The method of claim 1, wherein the steps further include:
generating scan results in response to performing the data scanning operations; and
sending, by the one or more scanner instances, metadata of the scan results to the cloud-based system.

9. The method of claim 1, wherein the orchestrator instance is hosted in an orchestrator private subnet of an orchestrator virtual private cloud (VPC), wherein the orchestrator private subnet allows the orchestrator instance to send health logs to the cloud-based system.

10. The method of claim 1, wherein an orchestrator virtual private cloud (VPC) and a scanner VPC are peered using peering connections, establishing a private communication between the orchestrator instance and the one or more scanner instances.

11. A non-transitory computer-readable storage medium having computer-readable code stored thereon for programming one or more processors of a cloud-based system to perform steps of:
establishing, within a hub account of a customer cloud organization, an orchestrator instance to organize data scanning operations across one or more regions where data of one or more target accounts within the customer cloud organization resides;
in response to a scan request received from the cloud-based system, dynamically launching one or more scanner instances by the orchestrator instance within the hub account of the customer cloud organization, in the one or more regions where the data scanning operations are performed; and
performing, by the one or more scanner instances within the hub account of the customer cloud organization, the data scanning operations on the data of the one or more target accounts in the one or more regions where the data resides.

12. The non-transitory computer-readable storage medium of claim 11, wherein the establishing includes deploying Data Security Posture Management (DSPM) templates to create Identity and Access Management (IAM) roles and permissions in the customer cloud organization using Cloud Service Provider (CSP) Application Programming Interfaces (APIs).

13. The non-transitory computer-readable storage medium of claim 12, wherein the IAM roles include:
an orchestrator instance profile role which is used by the orchestrator instance in the hub account to organize the data scanning operations;
a scanner instance profile role which is used by the one or more scanner instances in the hub account to perform the data scanning operations organized by the orchestrator instance; and
a target role which is assigned to one or more cloud accounts, wherein the cloud accounts become the one or more target accounts, enabling the one or more scanner instances to access resources within the one or more target accounts to perform the data scanning operations.

14. The non-transitory computer-readable storage medium of claim 12, wherein the deploying includes the IAM roles and permissions created by the DSPM templates that are used by the cloud-based system, the hub account, and the one or more target accounts.

15. The non-transitory computer-readable storage medium of claim 11, wherein the performing includes:
creating resources within a scanner virtual private cloud (VPC) located within the hub account of the customer cloud organization, wherein the scanner VPC hosts the one or more scanner instances in a scanner private subnet, wherein the resources include a database and a disk; and
mirroring the data from the one or more target accounts into the resources created within the scanner VPC.

16. The non-transitory computer-readable storage medium of claim 15, wherein the steps further include deleting, in response to completion of the data scanning operations, the one or more scanner instances along with the resources created within the scanner VPC for performing the data scanning operations.

17. The non-transitory computer-readable storage medium of claim 11, wherein the performing further includes accessing, by the one or more scanner instances, the data from a cloud storage of the one or more target accounts via a gateway or private endpoint.

18. The non-transitory computer-readable storage medium of claim 11, wherein the steps further include:
generating scan results in response to performing the data scanning operations; and
sending, by the one or more scanner instances, metadata of the scan results to the cloud-based system.

19. The non-transitory computer-readable storage medium of claim 11, wherein the orchestrator instance is hosted in an orchestrator private subnet of an orchestrator virtual private cloud (VPC), wherein the orchestrator private subnet allows the orchestrator instance to send health logs to the cloud-based system.

20. The non-transitory computer-readable storage medium of claim 11, wherein an orchestrator virtual private cloud (VPC) and a scanner VPC are peered using peering connections, establishing a private communication between the orchestrator instance and the one or more scanner instances.
